(19) United States
(12) Patent Application Publication
(10) Pub. No.: US 2005/0258577 A1
(43) Pub. Date: Nov. 24, 2005

(54) Method of producing unitary multi-element ceramic casting cores and integral core/shell system

(76) Inventors: John E. Holowczak, South Windsor, CT (US); Michael K. Sahm, Avon, CT (US); Wayde R. Schmidt, Pomfret Center, CT (US)

Correspondence Address: MCCORMICK, PAULDING & HUBER LLP, CITY PLACE II, 185 ASYLUM STREET, HARTFORD, CT, 06103, US

(21) Appl. No.: 10/850,211

(22) Filed: May 20, 2004

(51) Int. Cl. B28B 7/34

(52) U.S. Cl. 264/600; 249/176; 249/184; 249/62

(57) ABSTRACT

A method for producing ceramic articles having a complex geometry. Temporary tooling is provided having cavities corresponding in shape to the desired ceramic article. The cavities are filled with a ceramic slurry which is solidified by freezing or gelation of a polymer. The ceramic is treated to remove the original liquid portion of the slurry and the temporary tooling is removed. The ceramic is then sintered. The ceramic article thus obtained may be used to investment cast a metal article.

Methods are disclosed for fabricating unitary multi-element ceramic casting cores for fabrication of hollow castings having multiple thin walls, complex internal passages and other complex geometries. The method involves the use of multi-part molded wax or polymer temporary tools which are joined together to form a complex temporary tool containing cavities. The cavities are filled with a ceramic slurry which is then solidified. After the ceramic slurry is solidified the temporary tooling is removed. In another embodiment, shells may be formed in conjunction with the ceramic cores.

### BACKGROUND OF THE INVENTION

1. Field of the Invention

This invention relates to the fabrication of complex ceramic cores and combination complex unitary ceramic core shells for the production of complex castings. The method is particularly suited for the fabrication of certain components for gas turbine engines.

2. Description of Related Art

Hollow castings are widely used to produce gas turbine engine components. Gas turbine components are often cooled by flowing air through internal cavities. However, the use of cooling air, which is supplied from the compressor section of the engine, reduces operating efficiency. Consequently there is a desire to maximize the cooling effect of compressor cooling air to improve efficiency. Increasing cooling efficiency usually requires more complex internal passages. Gas turbine engine designers have devised many airfoil designs for improving cooling efficiency, however some of these designs have proven difficult to produce on a cost-efficient basis.

In particular, designers have recently focused their attention on castings which have multiple thin walls, usually double walls. This configuration is shown, for example, in U.S. Pat. No. 5,720,431 which is incorporated herein by reference. The difficulty arises in fabricating the ceramic casting cores which define the interior of the casting.

Conventional cores for single wall hollow castings, such as that shown schematically in FIG. 1A, are commonly produced by injecting a heated ceramic powder/polymer (or wax) mixture into a split die set which contains a cavity whose contours are essentially those of the desired core. The injection molded core is cooled, the dies are opened and the core is removed. The core is then heated to remove the polymer binder and then heated at a higher temperature to sinter the ceramic powder particles to form a durable ceramic core.

Split molds cannot be used to produce cores for double wall castings. The practice to date has been to fabricate these complex cores as multiple ceramic parts and then to cement or otherwise fasten these ceramic cores parts together to produce a unitary multi element core assembly. This approach has proven to be undesirable because the core parts are brittle and easily damaged, especially during handling.

New types of ceramic slurries, and associated processes have recently been developed. These include gel casting which is shown for example in U.S. Pat. Nos. 5,824,250 and 4,894,194 and freeze casting which is described in U.S. Pat. Nos. 4,975,225, 5,811,171, 6,024,259, and 6,368,525.

The gel casting system uses a ceramic slurry consisting of ceramic particles suspended in a carrier liquid comprised in part of a polymer precursor which polymerizes when heated. The ceramic slurry solidifies when the carrier polymerizes. The solidified article is treated to remove the polymer binder and then sintered.

Freeze casting is a ceramic article preparation scheme in which a ceramic slurry, usually having an aqueous based carrier, and containing a variety of other additives, is frozen to solidify the ceramic slurry. Sublimation or vacuum dewatering is then used to remove what was originally water in the ceramic slurry. After the water is removed the article is sintered.

### BRIEF SUMMARY OF THE INVENTION

According to the invention multi-part temporary tooling is fabricated from wax or polymeric materials using injection molding. Each of the parts of the temporary tooling has a configuration which permits production using split molding dies. The multiple temporary tooling parts are assembled to form a temporary tooling assembly containing cavities which have the configuration of the desired multi-part unitary ceramic core.

The cavities within the assembled temporary tooling are filled with a ceramic slurry which is preferably of a type which can be solidified by heating (e.g., a gel casting-type slurry), or by cooling (e.g., a freeze casting-type slurry).

In the case of the slurry which is formulated to harden by gelation, the filled temporary tooling is heated to the appropriate temperature to cause the ceramic slurry to gel. The temporary tooling may be removed at this point by thermal process such as melting or combustion or by solvent dissolution, or by combinations of these methods. Next, the original liquid in the gel casting slurry may be removed by further heating to cause the liquid to evaporate or by (flash) freezing followed by liquid removal by sublimation or by an appropriate technique. The solidified ceramic material is then sintered.

In the alternative embodiment of the invention, a ceramic slurry is provided which is formulated to be solidified by freezing. After the ceramic slurry contained in the temporary tooling is solidified by freezing, the temporary tooling may be removed by chemical dissolution or other suitable method. The original liquid in the frozen slurry may be removed by sublimation. If the original temporary tooling was not removed by chemical means, it may then be removed by thermal means. The ceramic material is then sintered.

At the end of either of the major embodiment processes, the result is a ceramic article containing cavities which accurately reflects the original configuration of the wax or polymer temporary tooling. This core (or core/shell system) can then be used as a core in a lost wax casting process.

### BRIEF DESCRIPTION OF THE DRAWINGS

FIG. 1A shows a section through a conventional single wall hollow airfoil;

FIG. 1B shows a section through a core used to produce the airfoil shown in FIG. 1A;

FIG. 1C shows a section through a core shown in FIG. 1B along with a surrounding shell mold;

FIG. 2A shows a cross-section through an airfoil of the type disclosed in U.S. Pat. No. 5,720,431;

FIG. 2B shows a cross-section through a core used to fabricate the airfoil shown in FIG. 2A;

FIG. 2C shows a section through a core as shown in FIG. 2B along with a surrounding integral shell mold;

FIG. 3 shows a cross-section through the tooling used to produce the core whose cross-section shown in FIG. 2B;

FIGS. 4A, 4B, 4C, 4D, and 4E show some attachment schemes which can be used to join the temporary tooling components together to form the temporary tooling shown in FIG. 3.

### DESCRIPTION OF THE PREFERRED EMBODIMENT

This invention relates to the production of hollow articles having complex internal configurations and is particularly suited for fabricating cooled airfoils for use in the turbine section of gas turbine engines. Other turbine engine components such as combustor components may also be fabricated using the present invention.

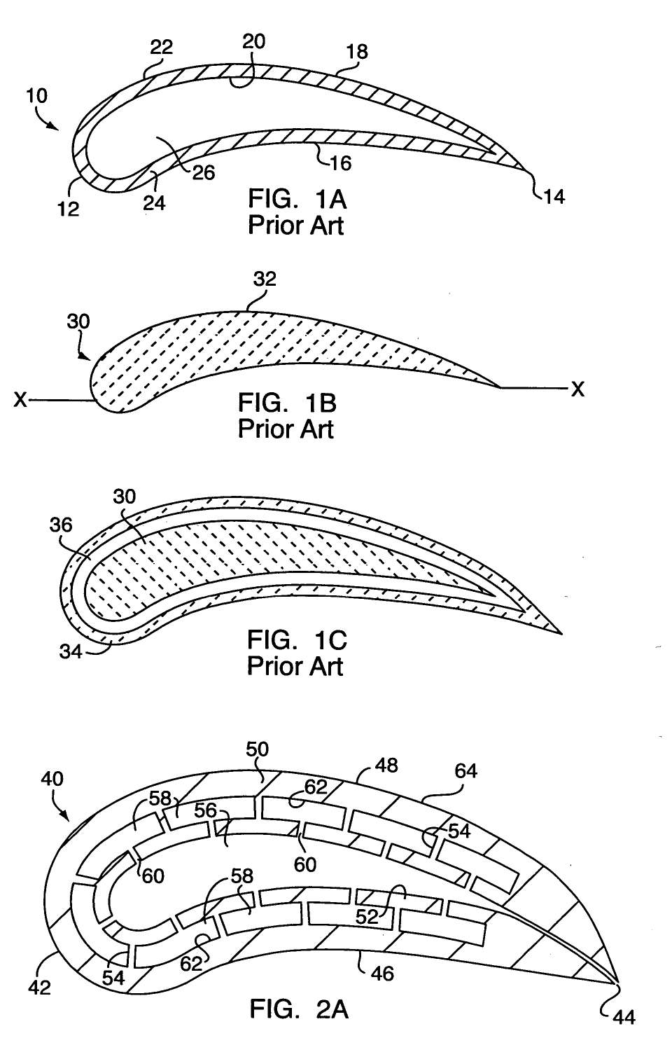

FIG. 1A shows a cross section of a conventional single wall hollow airfoil in schematic form. The airfoil 10 has a leading edge 12, a trailing edge 14, a pressure surface 16, and a suction surface 18. The airfoil 10 is hollow, and has an inner surface 20, which defines a cavity 26 and an outer surface 22. Surfaces 22 and 24 define a wall 24. The airfoil 10 will usually be made of a nickel or cobalt superalloy material. FIG. 1A shows an as-cast airfoil. Prior to being placed into service the as-cast airfoil will usually be drilled to provide cooling holes (not shown) through the wall 24 to permit a pressurized fluid to flow from the cavity 26, through the wall 24 and then over the exterior surface 22 to protect the airfoil from excessive temperatures. FIG. 1A depicts a simple single wall hollow airfoil, a more advanced hollow airfoil is shown and described in U.S. Pat. No. 5,599,166 which is incorporated herein by reference.

A hollow airfoil such as that shown in FIG. 1A will usually be formed by an investment casting process and a ceramic core will be provided to create the cavity 26. FIG. 1B shows a cross sectional view of a core that would be used to produce a hollow cast airfoil such as that shown in FIG. 1A. FIG. 1B shows a ceramic core 30 having an outer surface 32 which corresponds to the surface 20 shown in FIG. 1A. A ceramic core having the shape shown in FIG. 1B can be fabricated by injection molding a ceramic/polymer paste into a split die assembly which separates along line X-X.

FIG. 1B shows a core 30 which might be used to form the cavity 26 of the airfoil 10 shown in FIG. 1A. FIG. 1C shows how the core 30 shown in FIG. 1B would be used in combination with an exterior mold, shown here as shell mold 34 to provide a mold core cavity 36 which can be filled with metal to produce the hollow airfoil 10 shown in FIG. 1A.

FIG. 1C shows the core 30, previously described in FIG. 1B along with an external shell mold 34. Together, core 30 and shell mold 34 define a generally annular space or cavity 36. Cavity 36 has a size and configuration which are similar to the size and configuration of the airfoil 10 shown in FIG. 1A. Airfoil 10 may be produced by pouring molten metal into cavity 36, allowing the metal to solidify, and then removing the core 30 and the shell mold 34.

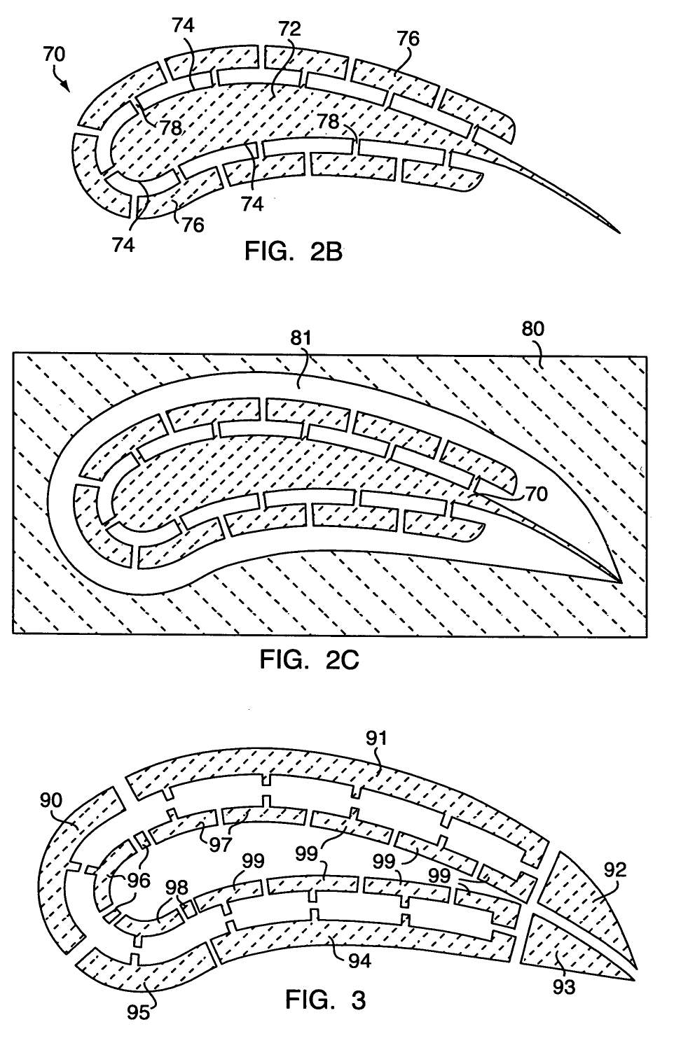

A more complex airfoil is shown in FIG. 2A, this airfoil is generally similar to that shown in U.S. Pat. No. 5,720,43. Airfoil 40 has a leading edge 42, a trailing edge 44, a pressure surface 46 and a suction surface 48. Airfoil 40 has an outer wall 50 and an inner wall 52 which are generally parallel and relatively uniformly spaced apart. Outer wall 50 is connected to inner wall 52 by multiple spacers 54. Outer wall 50, inner wall 52, and spacers 54 cooperate to form a stiff structure. Outer wall 50, inner wall 52, and spacers 54 also cooperate to form a plurality of channels 58 which are connected to central supply cavity 56. Central supply cavity 56 is in fluid connection with each channel 58 by means of multiple apertures 60. Enhanced cooling is provided by flowing pressurized cooling fluid into supply cavity 56, and then through cooling holes 60. Air flowing through cooling holes 60 impinges on the inner surface 62 of the outer wall 50 and cools wall 50. The cooling air then flows through multiple holes (not shown), which are drilled in the outer wall 50 to provide film cooling of the outer surface 64 of outer wall 50. In addition, the double wall construction provides strength and stiffness to the airfoil.

The fabrication of an airfoil such as that shown in FIG. 2A by casting requires a complex core to form the interior features of the airfoil. Such a complex core is illustrated in FIG. 2B. Core 70 includes inner ceramic element 72 whose outer surface 74 corresponds generally to the inner surface of the supply cavity 56 in FIG. 2A. Ceramic element 70 is connected to multiple elements 76 which correspond to supply channels 58 by elements 78 which correspond to holes 60 in FIG. 2A.

FIG. 2C shows the core assembly 70 of FIG. 2B surrounded by a ceramic mold 80, the combination of core 70 and mold 80 produce a complex cavity arrangement 81. Cavity 81 corresponds in shape to the airfoil of FIG. 2A.

It will be appreciated that the complex ceramic core shown in FIG. 2B cannot be fabricated by injection molding into a split die—no die parting line can be drawn which will permit separation of the dies without damaging the injection molded component.

The present invention provides a process to produce ceramic cores which in cross-section are multi-part cores, such as that shown in FIG. 2B, through which a single parting line cannot be drawn.

The invention utilizes what will be termed temporary tooling. Temporary tooling in this application will be fabricated from a wax or polymeric material such as polyethylene, polypropylene and other thermoplastics including without limitation, acetyl, nylon, polyamide, polycarbonate, polystyrene, polyester, and blends thereof. These materials are selected so that they can be easily removed. The temporary tooling is fabricated in multiple elements, each of which can be produced by injection molding into a split die. The multiple elements are then joined together and used as a mold to form the ceramic core.

An advantage of the invention is that the elements which are joined are made of a polymeric material and are therefor not brittle. The polymeric elements can be manipulated and joined with little likelihood of damage. This is in contrast to prior methods in which brittle ceramic elements are assembled to form the core. In the prior method, damage to the brittle ceramic elements is quite common.

FIG. 2C shows how the complex ceramic core 70 of FIG. 2B can be used in combination with a surrounding ceramic mold 80 to define a complex cavity 82 whose shape corresponds to the airfoil shown in FIG. 2A. Mold 80 may be formed by solidifying a ceramic slurry, or may be formed using conventional shell molding techniques. Mold 80 and core 70 may be formed separately or in combination.

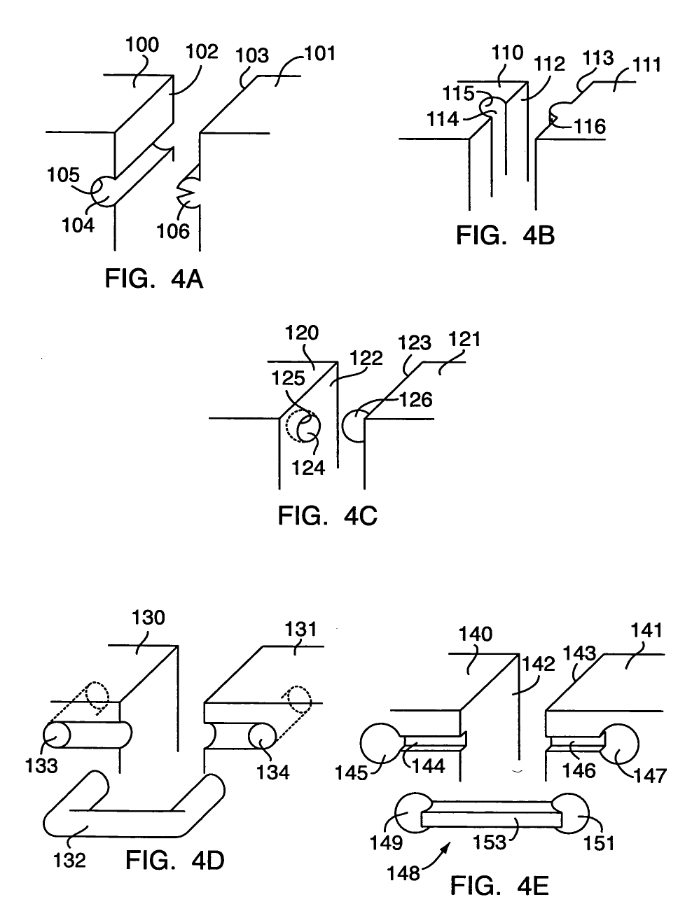

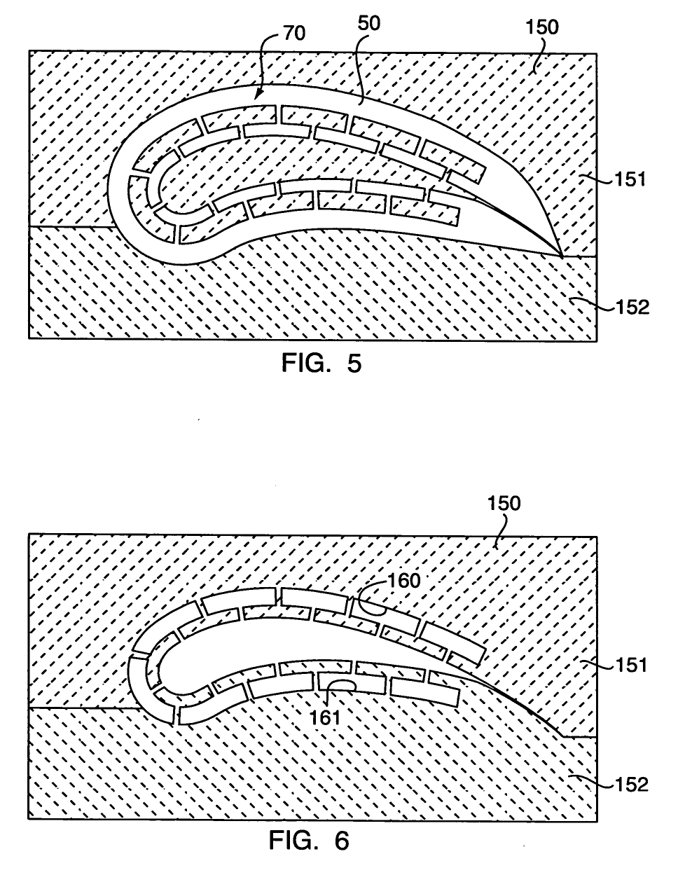

FIG. 3 illustrates an exemplary arrangement which uses multi element temporary tooling to form a core for a multi wall airfoil. The temporary tooling is made in nine elements 90, 91, 92, 93, 94, 95, 96, 97, 98 and 99. Each of elements 90-99 can be formed by injection molding into a split die. The temporary airfoil tooling elements have features which permit the sections to fit together in an accurate fashion. Examples of these features are shown in FIGS. 4A, 4B, 4C, 4D, and 4E.

FIGS. 4A-4E illustrate mechanical interlocking features which may be used to join temporary tooling elements. In FIGS. 4A-4C, the interlocking features include a protrusion or male feature on one tooling element that fits into a mating recess or female feature in the adjoining tooling element. In FIGS. 4D and 4E, the tooling elements are joined by an independent connecting element. The connecting elements shown in FIGS. 4D and 4E have male features that are received within female features disposed within the tooling elements. In alternative embodiments, the male and female features may each be disposed in the other of the tooling element and connecting element, respectively.

FIG. 4A shows how tooling elements 100 and 101 maybe joined along surfaces 102 and 103. Tooling element 100 has an under undercut groove 104 defined by surface 105 that extends below surface 102. Protrusion 106 extends outward from surface 103 of tooling element 101. Protrusion 106 fits into groove 104. Protrusion 106 is split so that, when it is forced into groove 104, undercut groove 104 will retain protrusion 106, thereby joining tooling elements 100 and 101 across surfaces 102 and 103.

FIG. 4B shows a similar arrangement to that shown in FIG. 4A, wherein tooling elements 110 and 111 are joined across surfaces 112 and 113. Protrusion 116 is forced into an interlocking relationship with recess 114, which is defined by surface 115. Recess 114 may be undercut and projection 116 may be split, as shown in FIG. 4A, or projection 116 may be solid and may be force fit into recess 114.

FIG. 4C is similar to FIGS. 4A and 4B in that a protrusion 126 fits into a recess 124 to hold temporary tooling elements 121 and 122 together along surfaces 122 and 123. Projection 126, which is shaped like a partial sphere, extends from surface 123 of element 121. Projection 126 is sized and shaped to fit into undercut recess 124, which is defined by surface 125, in surface 122 of element 120.

FIGS. 4D and 4E illustrate the use of independent connectors to hold tooling elements together. In FIG. 4D, tooling elements 130 and 131 are held together by shaped link 132, which fits into passages 133 and 134 which extend into articles 130 and 131 respectively. FIG. 4E shows the use of dog bone shaped link 148 to join articles 140 and 141. The shaped link 148 includes a pair of protrusions 149 and 151, connected to one another by member 153. Protrusions 149 and 151 of link 148 fit into recesses 145 and 147, and member 153 fits into recesses 144 and 146 in articles 140 and 141. Bonding aids such as heat, adhesives, ultrasonic welding, and combinations thereof may be used alone, or in conjunction with mechanical interlocking arrangements such as those discussed above.

The fit between the protrusion and the recess can be an interference fit; e.g., mating features that snap together, or mating features that collectively form a slight press fit, etc. Appropriate bonding agents can be used in combination with, or in place of, the interference fit. Bonds between the mating features may also be enhanced by solvent softening and/or heating, alone or in conjunction with other attachment methods.

The attachment schemes shown in FIGS. 4A, 4B, and 4C have been described as using undercut recesses. The undercut aspect of the recess is optional especially if bonding aids such as glue, heat or ultrasonic welding are employed.

The attachment schemes shown and described above are exemplary and are not limiting.

The temporary tooling is usually removed after the ceramic slurry has been solidified, and either before or after the suspension carrier is removed. The temporary tooling may be removed by any means which does not adversely affect the integrity of the solidified ceramic material. In general, two techniques will be used, thermal removal and removal by solvent extraction. Thermal removal is performed by heating the temporary tooling to a temperature at which it either melts, and can be flowed out, simply evaporates, or decomposes and/or reacts with a gaseous environment to form easily removed gaseous products. Thermal removal by decomposition may be accomplished in an oxidizing atmosphere. Solvent extraction consists of dissolving the temporary tooling in an appropriate solvent. Combinations of thermal and solvent extraction processes may also be utilized. Indirect means to heat the temporary tooling, as in microwave or radio frequency waves, may also be used.

A ceramic slurry consists of fine ceramic particles, having a particle size less than about 200 microns, suspended in a liquid carrier. The carrier will generally be an aqueous based liquid and will usually contain various additives, such as ceramic sols and wetting agents, depending on the ceramic particle materials used and upon the intended subsequent processing of the ceramic slurry.

After solidification and removal of the carrier material, the ceramic material will be relatively soft and porous. The soft porous ceramic material may be machined. For most applications the soft porous ceramic will be sintered to reduce porosity and increase strength and hardness. Sintering is accomplished by heating the ceramic material to a temperature at which the particles interact and further bond. The temperature and time conditions required for sintering will be determined by the ceramic composition and the particle size.

Referring back to FIG. 2A, it will be appreciated that outer wall 50 contains and supports the entire structure 40 during the solidification of the slurry within the various interior cavities. The slurry may expand or contract during solidification, expansion is particularly likely when the slurry is solidified by freezing. In some situations, the outer wall 50 may be strong enough to resist the stresses resulting from slurry solidification, but it may be desirable to provide a supporting structure exterior to wall 50.

Although this invention has been shown and described with respect to the detailed embodiments thereof, it will be understood by those skilled in the art that various changes in form and detail thereof may be made without departing from the spirit and the scope of the invention.

1. A method of fabricating a unitary, multi-element ceramic article comprising:
a) preparing multiple disposable tool elements configured to be joined together to define multiple cavities that mirror the geometry of the unitary multi-element ceramic article;
b) joining the disposable tool elements together to form multiple cavities;
c) filling the cavities with a ceramic slurry having a liquid carrier;
d) solidifying the ceramic slurry;
e) removing the disposable tool elements.

2. A method as in claim 1, wherein the unitary multi-element ceramic article is a casting core.

3. A method as in claim 1, wherein preparing the disposable tool elements includes forming the disposable tool elements from a polymeric material.

4. A method as in claim 1, wherein preparing said disposable tool elements includes injection molding the disposable tool elements.

5. A method as in claim 1, wherein joining the disposable tool elements includes mating mechanical interlocking features of the disposable tool elements.

6. A method as in claim 5, wherein the mechanical interlocking features include male and female details.

7. A method as in claim 1, wherein joining the disposable tool elements includes bonding the disposable tool elements together.

8. A method as in claim 1, wherein solidifying the ceramic slurry includes cooling the ceramic slurry to cause the liquid carrier to freeze.

9. A method as in claim 1, wherein:
filling the cavities includes filling said cavities with a ceramic slurry having a liquid carrier and a polymeric precursor; and
solidifying the ceramic slurry includes heating the ceramic slurry to cause the polymeric precursor to polymerize.

10. A method as in claim 1, wherein removing the disposable tool elements includes removal by solvent extraction.

11. A method as in claim 8, wherein removing the disposable tool elements includes removal by a thermal treatment.

12. A method as in claim 1, further comprising treating the ceramic slurry to remove at least a portion of the slurry carrier.

13. A method as in claim 1, further comprising, after removing the disposable tool elements, treating the solidified ceramic slurry to remove at least a portion of the slurry carrier.

14. A method as in claim 1 further comprising, treating the solidified ceramic slurry to remove at least a portion of the slurry carrier before removing the disposable tool elements.

15. A method as in claim 13, further comprising sintering the solidified ceramic slurry after removing at least a portion of the slurry carrier.

16. A method as in claim 14, further comprising sintering the solidified ceramic slurry after removing of at least a portion of the slurry carrier.

17. A disposable mold assembly for producing unitary multiple element ceramic articles comprising:
a plurality of disposable tool elements; and
at least one interlocking feature located on each of the disposable tool elements, wherein the plurality of disposable tool elements are configured to connect via the interlocking features to form a multi cavity mold.

18. A mold assembly as in claim 17, wherein the plurality of disposable tool elements are formed by injection molding polymeric material.

19. A mold assembly as in claim 17, wherein the at least one interlocking feature includes at least one of a male detail and a female detail.

20. A mold assembly as in claim 17, wherein the at least one interlocking feature connects with an adhesive.

21. A system for fabricating a unitary, multi-element ceramic article comprising:
a plurality of multiple disposable tool elements configured to be joined together to define multiple cavities that mirror the geometry of the unitary multi-element ceramic article;
a joining structure configured to couple the disposable tool elements together to form multiple cavities;
a ceramic slurry having a liquid carrier filling the form cavities;
a means for solidifying the ceramic slurry; and
a means for removing the disposable tool elements.
